(19) United States
(12) Patent Application Publication
(10) Pub. No.: US 2004/0173976 A1
(43) Pub. Date: Sep. 9, 2004

(54) Resilient seal with axial protrusions

(76) Inventor: Todd C. Boggs, Lebanon, TN (US)

Correspondence Address: BIEBEL & FRENCH, 35 EAST FIRST STREET, DAYTON, OH, 45402

(21) Appl. No.: 10/124,851

(22) Filed: Apr. 18, 2002

Related U.S. Application Data
(60) Provisional application No. 60/284,479, filed on Apr. 18, 2001.

(51) Int. Cl. F16J 3/00

(52) U.S. Cl. 277/628

(57) ABSTRACT

A seal comprises a body portion and one or more protrusions extending from said body portion. The body portion defines a directing curve; a generating curve defining a shape; and a plurality of cross-sectional planes normal to the directing curve such that cross-sections of the body portion taken along each cross-sectional plane of said plurality of cross-sectional planes have substantially the shape of the generating curve. The one or more protrusions intersect one or more of the cross-sectional planes. The directing curve defines a normal direction along each one of the cross-sectional planes such that one or more components of the protrusions extend along each cross-sectional plane transversely (that is, perpendicularly or obliquely) to the normal direction defined along that cross-sectional plane. Most preferably, these one or more components serve to resist twisting of the seal during placement and use.

### CROSS-REFERENCE TO RELATED APPLICATION

This application claims the benefit of U.S. Provisional Application No. 60/284,479, filed Apr. 18, 2001.

### FIELD OF THE INVENTION

The present invention relates generally to seals and, more particularly, to seals provided with one or more protrusions designed to resist twisting when the seal is positioned and used.

### BACKGROUND OF THE INVENTION

The present invention relates to improvements to seals. More specifically, the present invention relates to improvements to a type of seal including a body portion having an outer surface. The preferred outer surface is shaped substantially as the envelope formed by propagating a closed, planar generating curve along a closed, piecewise-smooth directing curve. In other words, if one took a sequence of cross-sections of the body portion along cross-sectional or cutting planes normal (that is perpendicular), to the directing curve, the shape of each cross-section would be substantially the same as the shape of the generating curve. Each point of the directing curve defines a normal direction which lies in the cross-sectional plane cutting through that point.

A familiar example of such a seal is an O-ring seal. Conventional O-ring seals comprise elastomeric body portions having substantially toroidal or “doughnut” shapes. As illustrated in FIG. 41, a toroidal shape 2 defines a directing circle 4 lying in a radial plane (not shown) and a plurality of cross-sectional planes 6 (only one shown in FIG. 41) perpendicular to the directing circle 4 and the radial plane (not shown). Each cross-sectional plane 6 cuts the toroidal shape 2 such that the cross-sections of the toroidal shape 2 taken along the cross-sectional planes 6 define circular cross-sections 8 corresponding to a circular generating curve (not shown) of the same shape. When O-ring seals are installed in annular grooves and subjected to pressure by mating surfaces, the elasticities of the O-rings enable them to engage the annular grooves and facing surfaces to produce stable seals between the annular grooves and the facing surfaces.

Protrusions extending from the toroidal body portions of the O-rings serve a variety of purposes. These purposes include providing specific stabilization of the seal, press-in-place retention features, centering features, and identification features.

In many commercially available face or press-in-place O-ring seals, it is known to provide protrusions extending inwardly or outwardly, or both, along the radial planes defining the body portions of the O-rings. One such configuration, which is useful, for example, in forming a seal between a face plate and an annular groove in the surface of a housing surrounding a bore, comprises disc-shaped protrusions extending radially inwardly and outwardly from the body portion. Typically, O-rings having such radial protrusions are formed by casting elastomeric material in molds configured so as to form parting planes which approximately coincide with the radial planes of the O-rings.

These radial protrusions fail to prevent the seals from twisting or rotating about the directing circles which define their body portions when the O-rings are subjected to unbalanced shear forces. For example, as an O-ring is forced over the outer surface of a shaft toward an annular groove in that surface, it is believed that various annular sections of the O-ring tend to experience different combinations of rolling and sliding movement along the outer surface of the shaft. Such differential movement between the various annular sections induces torsional stresses which cause sections of the O-ring to twist about the directing circle of the O-ring.

In many cases, this twisting compromises the seal cross-section at discrete locations along the directing circle. More specifically, it is believed that the unbalanced shear forces acting on the O-ring can generate torsional stresses which are not uniform along the directing circle. Those sections of the O-rings subjected to greater torsional moments will have reduced cross-sectional areas and will be less resilient with respect to external forces than those sections subjected to lesser torsional moments. As a consequence, those sections of the O-rings subjected to greater torsional moments will have a greater susceptibility to leakage than would an O-ring of comparable shape and composition with no twisting. This twisted orientation often is difficult to detect while a system incorporating the seal is being assembled.

When an O-ring twists in this manner, the parting line along the outer surface of the O-ring twists into a corkscrew pattern resembling the stripes on a candy cane. This implies that one or more sections of the parting line do not face the annular groove on the shaft and the inner surface of a bore into which the shaft is inserted. This tendency affects the ability of the O-ring to engage these surfaces, thereby affecting the integrity of the seal.

In an attempt to minimize potential seal problems associated with the parting line location on the seal surface, some seals are molded with alternative parting line locations. However, even these alternate molding methods fail to address the sealing problems that often are incurred when sealing annular grooves such as annular grooves on the surfaces of shafts.

As a result, manufacturers have applied much expense and effort to assembly processes and subsequent verification processes to confirm that such seals are not twisted. For example, one such verification process involves marking, or painting, one side of a seal surface with a stripe so as to provide improved visual evidence of twisting. Although this system has practical application, the uneven distribution of paint or globs of marking medium on the seal surface itself can affect the integrity of the seal. Beside this, marking the seal does nothing to prevent twisting in the first instance. In spite of such expensive detection systems and inspection efforts, such twisting continues to increase manufacturing costs associated with O-ring seals.

Even if a seal is assembled properly around a shaft, it still is possible for the seal to twist or roll when the shaft is inserted into a bore. If a conventional seal does become twisted after being inserted into the bore, it is almost impossible to detect the twisting visually or with tactile means. While it has been observed that twisted seals still may satisfactorily seal following installation, they ultimately can fail in service as a result of being subjected to vibrational and other stresses. Even leak decay or pressurization tests are not always sensitive enough to detect twisted seals. In other words, such seals have sufficient integrity to pass leak testing of assemblies in which they are installed but begin to leak soon after the assemblies are placed into service.

There are many systems employed to try and prevent this situation, such as lubrication, grease, self-lubricating compounds, reduced friction surfaces and the like. In some applications, the seal is glued or caulked in place in an attempt to provide sufficient force holding the seal in place to overcome the relative twisting forces encountered during insertion. Notably, these methods involve extra steps and materials which tend to increase manufacturing costs associated with the O-ring seals.

Even if the seal is assembled properly on the shaft, and even if this is inserted properly into the bore, it is possible for cyclic motion of the bore relative to the shaft to cause the seal to twist in place. Detection systems capable of confirming proper assembly are not useful after such assemblies are in the field.

### SUMMARY OF THE INVENTION

Accordingly, the present invention overcomes the limitations of known seals by providing a seal comprising a body portion and one or more protrusions extending from said body portion. The body portion defines a directing curve; a generating curve defining a shape; and a plurality of cross-sectional planes normal to the directing curve such that cross-sections of the body portion taken along each of these cross-sectional planes have substantially the shape of the generating curve. The one or more protrusions intersect one or more of the cross-sectional planes. The directing curve defines a normal direction along each one of the cross-sectional planes such that one or more components of the protrusions extend along each cross-sectional plane transversely (that is, perpendicularly or obliquely) to the normal direction defined along that cross-sectional plane. Most preferably, these one or more components serve to resist twisting of the seal during placement and use.

In accordance with one preferred embodiment, a seal comprises a body portion and one or more protrusions extending from said body portion. The body portion defines a radial plane; a directing curve lying in the radial plane; a generating curve defining a shape; and a plurality of cross-sectional planes normal to the directing curve such that cross-sections of the body portion taken along each of these cross-sectional planes have substantially the shape of the generating curve. The one or more protrusions intersect one or more of the cross-sectional planes. One or more components of the protrusions extend along each of the cross-sectional planes which intersect the one or more protrusions along directions transverse to the radial plane. In accordance with yet another preferred embodiment, a seal comprises an annular body portion defining a radial plane and one or more protrusions extending from the annular body portion transversely to the radial plane.

Numerous embodiments lie within the scope of the invention. For example, the shape of the generating curve is not critical to the invention and preferred shapes include, without limitation, circular, triangular, square, pentagonal, hexagonal, hour-glass-shaped and bullet-shaped.

Likewise, numerous variations on the configuration of the protrusions are possible within the scope of the invention. Thus, preferred embodiments include, without limitation, seals having either one or more protrusions continuous along the length of the directing curve or one or more rows of protrusions extending along the length of the directing curve. Especially preferred embodiment include seals in which the protrusions extend from single sides of the body portions, singly or in oppositely-oriented pairs; or from opposite sides of the body portion.

In accordance with another preferred embodiment of the invention, a method for sealing a shaft in a bore comprises the steps of providing an annular groove through a surface of one of the shaft and the bore in a manner known to those of ordinary skill in the art; forcing a seal designed in accordance with the invention into the annular groove; and inserting the shaft into the bore so that the seal engages the shaft and the bore.

The preferred seal of the invention is designed to resist twisting during assembly or use of a system including the seal as well as to faciliate detection of any twisting which occurs during assembly. For example, it is believed that the configuration of the preferred seal is such that the effective outer diameter of the preferred seal in its twisted state exceeds that of the seal at rest while the effective inner diameter of the seal in its twisted state is less than that at rest. This limits twisting of the seal as the seal is positioned in an annular groove through the surface of a shaft. It is also believed that the configuration of the preferred seal is such as to increase the effective torsional moment arm of the seal when the seal exceeds a certain level of twist, thereby limiting the amount of twist for a given external shear force. Additionally, it is believed that the preferred seal is subject to hysteresis or “memory” that tends to relieve any twisting of the seal which may occur during assembly.

The configuration of the preferred seal not only serves to resist twisting, but also facilitates detection of such twisting by visual, tactile, leak testing, insertion force or other conventional detection means. The configuration of the preferred seal promotes the detection of such twisting by means of simple leak decay or pressurization tests. Alternatively, the amount of force required to position the preferred seal provides an indication of whether the seal has twisted, since a twisted seal requires significantly more insertion force than a properly-assembled seal requires. Likewise, the invention facilitates the detection of twisting visually or by touch, even by seeing-impaired individuals.

Other objects and advantages of the invention will be apparent from the following description, the accompanying drawings and the appended claims.

### BRIEF DESCRIPTION OF THE DRAWINGS

FIG. 1 is a perspective view of one embodiment of the present invention;

FIG. 2 is a side elevational view of the embodiment of FIG. 1;

FIG. 3 is a cross-sectional view of the embodiment of FIG. 2 taken along the line 3-3;

FIG. 4 is a side elevational view of another embodiment of the present invention;

FIG. 5 is a cross-sectional view of the embodiment of FIG. 4 taken along the line 5-5;

FIG. 6 is a side elevational view of another embodiment of the present invention;

FIG. 7 is a cross-sectional view of the embodiment of FIG. 6 taken along the line 7-7;

FIG. 8 is a side elevational view of another embodiment of the present invention;

FIG. 9 is a cross-sectional view of the embodiment of FIG. 8 taken along the line 9-9;

FIG. 10 is a side elevational view of another embodiment of the present invention;

FIG. 11 is a cross-sectional view of the embodiment of FIG. 10 taken along the line 11-11;

FIG. 12 is a side elevational view of another embodiment of the present invention;

FIG. 12A is a cross-sectional view of the embodiment of FIG. 12 taken along the line 12A-12A;

FIG. 13 is a side elevational view of another embodiment of the present invention;

FIG. 13A is a cross-sectional view of the embodiment of FIG. 13 taken along the line 13A-13A;

FIG. 14 is a side elevational view of another embodiment of the present invention;

FIG. 14A is a cross-sectional view of the embodiment of FIG. 14 taken along the line 14A-14A;

FIG. 15 is a side elevational view of another embodiment of the present invention;

FIG. 15A is a cross-sectional view of the embodiment of FIG. 15 taken along the line 15A-15A;

FIG. 16 is a side elevational view of another embodiment of the present invention;

FIG. 16A is a cross-sectional view of the embodiment of FIG. 16 taken along the line 16A-16A;

FIG. 17 is a side elevational view of another embodiment of the present invention;

FIG. 17A is a cross-sectional view of the embodiment of FIG. 17 taken along the line 17A-17A;

FIG. 18 is a side elevational view of another embodiment of the present invention;

FIG. 18A is a cross-sectional view of the embodiment of FIG. 18 taken along the line 18A-18A;

FIG. 19 is a side elevational view of another embodiment of the present invention;

FIG. 19A is a cross-sectional view of the embodiment of FIG. 19 taken along the line 19A-19A;

FIG. 20 is a side elevational view of another embodiment of the present invention;

FIG. 20A is a cross-sectional view of the embodiment of FIG. 20 taken along the line 20A-20A;

FIG. 21 is a side elevational view of another embodiment of the present invention;

FIG. 21 A is a cross-sectional view of the embodiment of FIG. 21 taken along the line 21A-21A;

FIG. 22 is a side elevational view of another embodiment of the present invention;

FIG. 22A is a cross-sectional view of the embodiment of FIG. 22 taken along the line 22A-22A;

FIG. 23 is a side elevational view of another embodiment of the present invention;

FIG. 23A is a cross-sectional view of the embodiment of FIG. 23 taken along the line 23A-23A;

FIG. 24 is a side elevational view of another embodiment of the present invention;

FIG. 24A is a cross-sectional view of the embodiment of FIG. 24 taken along the line 24A-24A;

FIG. 25 is a side elevational view of another embodiment of the present invention;

FIG. 25A is a cross-sectional view of the embodiment of FIG. 25 taken along the line 25A-25A;

FIG. 26 is a side elevational view of another embodiment of the present invention;

FIG. 26A is a cross-sectional view of the embodiment of FIG. 26 taken along the line 26A-26A;

FIG. 27 is a side elevational view of another embodiment of the present invention;

FIG. 27A is a cross-sectional view of the embodiment of FIG. 27 taken along the line 27A-27A;

FIG. 28 is a side elevational view of another embodiment of the present invention;

FIG. 28A is a cross-sectional view of the embodiment of FIG. 28 taken along the line 28A-28A;

FIG. 29 is a side elevational view of another embodiment of the present invention;

FIG. 29A is a cross-sectional view of the embodiment of FIG. 29 taken along the line 29A-29A;

FIG. 30 is a side elevational view of another embodiment of the present invention;

FIG. 30A is a cross-sectional view of the embodiment of FIG. 30 taken along the line 32A-30A;

FIG. 31 is a side elevational view of another embodiment of the present invention;

FIG. 31A is a cross-sectional view of the embodiment of FIG. 31 taken along the line 31A-31A;

FIG. 32 is a side elevational view of another embodiment of the present invention;

FIG. 32A is a cross-sectional view of the embodiment of FIG. 32 taken along the line 32A-32A;

FIG. 33 is a front plan view of another embodiment of the present invention;

FIG. 33A is a cross-sectional view of the embodiment of FIG. 33 taken along the line 33A-33A;

FIG. 34 is a perspective view of another embodiment of the present invention;

FIG. 35 is a partially cut-away view showing the seal of FIG. 6 received within an annular groove through an outer surface of a shaft which is situated inside a bore in a sleeve;

FIG. 36 is a schematic sectional view showing the sleeve, seal and annular groove of FIG. 35;

FIG. 37 is a schematic sectional view showing the seal of FIG. 6 positioned in an annular raceway defined in a bore which at least partially encloses a shaft;

FIG. 38 is a schematic view showing the seal and annular groove of FIGS. 35 and 36;

FIG. 39 is a schematic view showing the seal of FIG. 6 in a twisted condition;

FIG. 40 is a schematic view showing the seal of FIG. 8 in a twisted condition in an annular groove through an outer surface of a shaft; and

FIG. 41 is a schematic view showing the generation of a torus by means of propagating a generating circle along a directing circle.

### DETAILED DESCRIPTION OF THE PREFERRED EMBODIMENT

In order to provide a clear description of the best mode for carrying out the invention, numerous embodiments will be described and, in some instances, compared. Nevertheless, it will be recognized that the appended claims, and not the particular embodiments explicitly described herein, define the invention.

It is easiest to describe the invention in terms of O-rings seals. As discussed earlier, the body portion of an O-ring seal is annular, that is, it defines a directing curve which is circular. Since the directing curve of an annular body portion lies along a radial plane, the normal directions to the directing curve coincide with the intersections between the radial plane and the cross-sectional planes. Thus, any direction lying along a cross-sectional plane which is transverse to the radial plane will also be transverse to the normal direction within that cross-sectional plane.

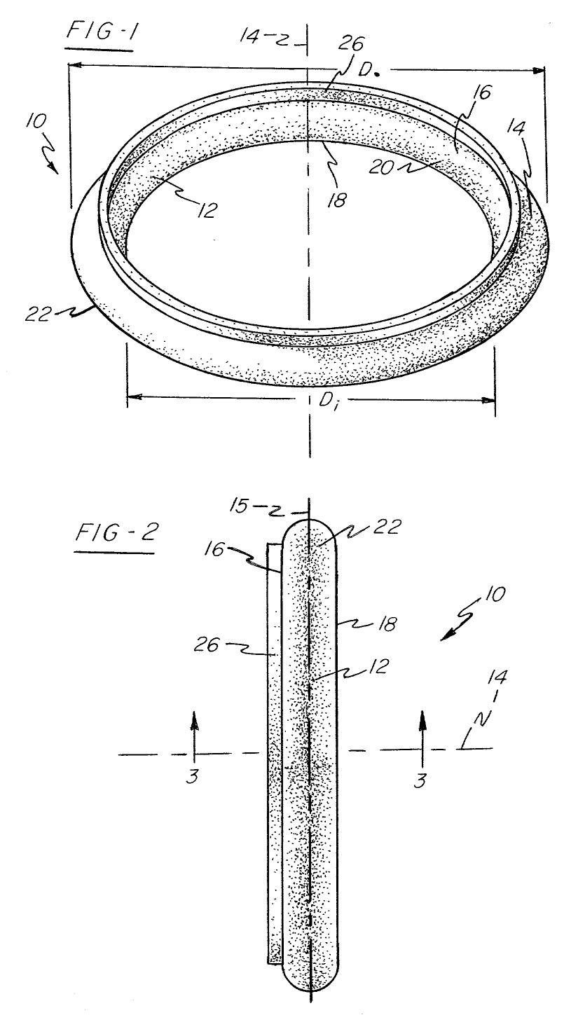

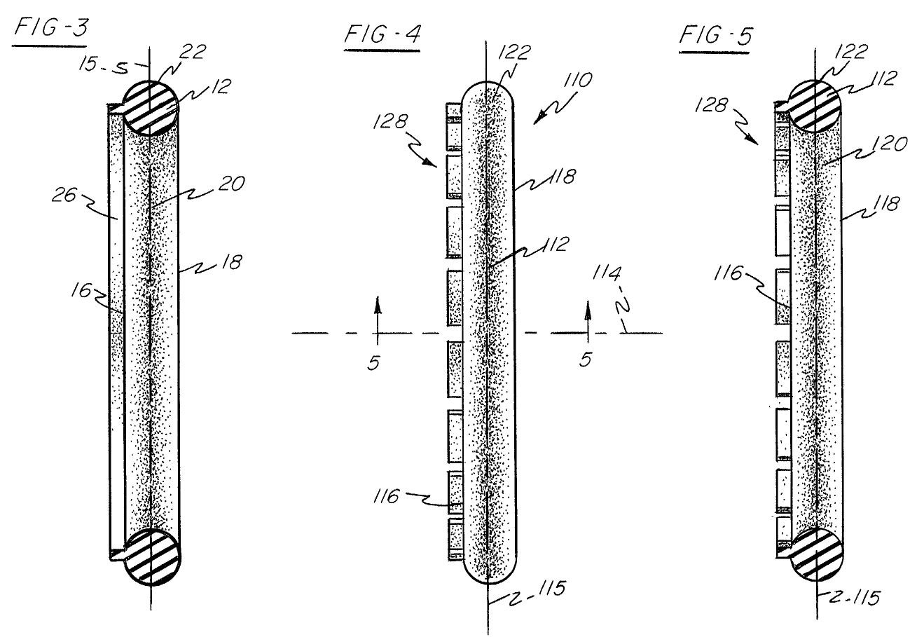

As can be seen in FIGS. 1-3, a seal 10 (FIGS. 1 and 2) comprises a generally annular body portion 12 disposed about a central axis 14 (FIGS. 1 and 2) which defines a radial plane 15 (FIGS. 2 and 3) perpendicular to the central axis 14 and a directing circle (not shown) lying in the radial plane 15. The body portion 12 defines opposing first and second sides or surface quadrants 16 and 18 connected by opposing inner and outer diameter sides or surface quadrants 20 (FIGS. 1 and 3) and 22 which respectively define inner and outer diameters Dᵢ and Dₒ (FIG. 1). A continuous protrusion 26 is disposed about the central axis 14 and extends outwardly from the first side 16. Most preferably, the protrusion 26 comprises a rectangular flange or wall extending from the first side 16 in a direction perpendicular to the radial plane 15 (FIGS. 2 and 3), that is, in a direction parallel to the central axis 14 (FIGS. 1 and 2) which is itself perpendicular to the radial plane 15. Those skilled in the art will recognize that it is within the scope of the invention to employ a similar protrusion (not shown) extending from the second side 18.

FIGS. 4-5 show another seal 110 (FIG. 4) defining a body portion 112; a central axis 114 (FIG. 4); a radial plane 115; first and second sides 116 and 118; and inner and outer diameter sides 120 (FIG. 5) and 122. A row or annular array of spaced-apart protrusions 128 is disposed about the central axis 114 (FIG. 4) and extends outwardly from the first side 116. Most preferably, the row of protrusions 128 comprises a row of crenellated, rectangular flanges or walls extending from the first side 116 in a direction perpendicular to the radial plane 115. Those skilled in the art will recognize that it is within the scope of the invention to employ a similar row of protrusions (not shown) extending from the second side 118.

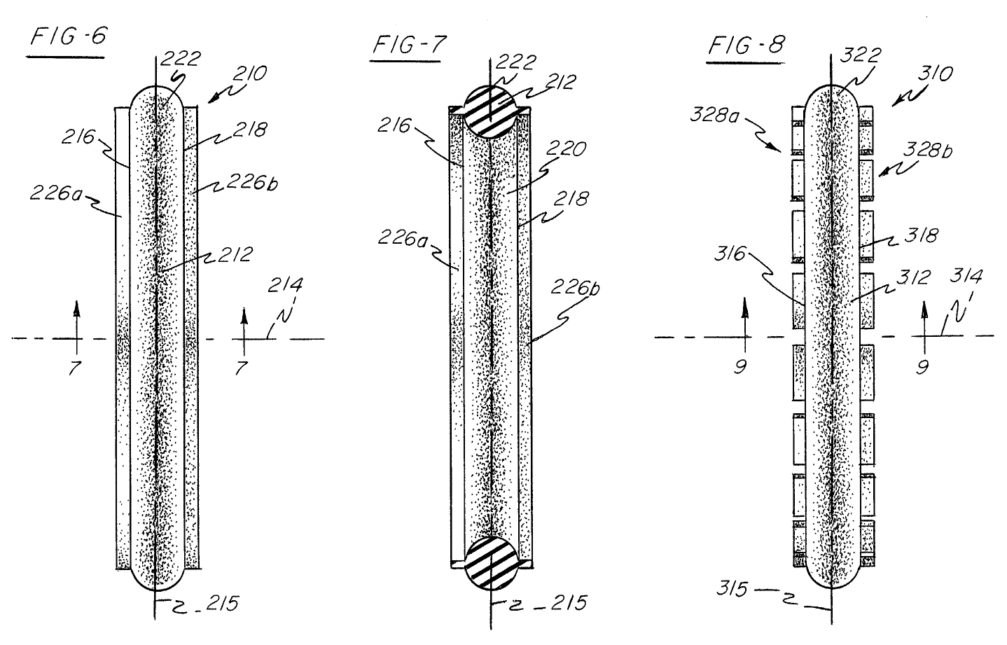

In another embodiment, as shown in FIGS. 6-7, a seal 210 (FIG. 6) defines a body portion 212; a central axis 214 (FIG. 6); a radial plane 215; first and second sides 216 and 218; and inner and outer diameter sides 220 (FIG. 7) and 222. Continuous protrusions 226a and 226b are disposed about the central axis 214 (FIG. 6) and extend outwardly from the first and second sides 216, 218. Most preferably, the protrusions 226a, 226b each comprise a rectangular flange or wall extending from the first and second sides 216, 218 perpendicularly to the radial plane 215.

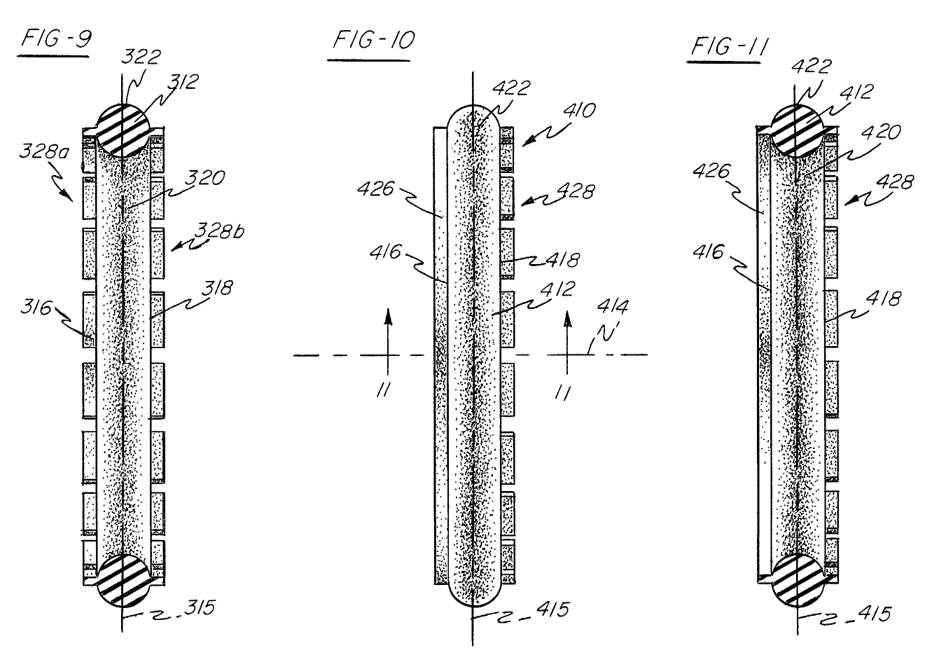

FIGS. 8-9 show a seal 310 (FIG. 8) defining a body portion 312; a central axis 314 (FIG. 8); a radial plane 315; first and second sides 316 and 318; and inner and outer diameter sides 320 (FIG. 9) and 322. Rows or annular arrays of spaced-apart protrusions 328a and 328b are disposed about the central axis 314 (FIG. 8) and extend outwardly from the first and second sides 316, 318. Most preferably, each row of protrusions 328a, 328b comprises a row of crenellated, rectangular flanges or walls extending from the first and second sides 316, 318 perpendicularly to the radial plane 315.

In yet another embodiment, FIGS. 10-11 show a seal 410 (FIG. 10) defining a body portion 412; a central axis 414 (FIG. 10); a radial plane 415; first and second sides 416 and 418; and inner and outer diameter sides 420 (FIG. 11) and 422. A continuous protrusion 426 is disposed about the central axis 414 (FIG. 10) and extends outwardly from the first side 416. Most preferably, the protrusion 426 comprises a rectangular flange or wall extending from the first side 416 in a direction perpendicular to the radial plane 415. A row of spaced-apart protrusions 428 is disposed about the central axis 414 (FIG. 10) and extends outwardly from the second side 418. Most preferably, the row of protrusion 428 comprises a row of crenellated, rectangular flanges or walls extending from the first side 416 in a direction perpendicular to the radial plane 415. Those skilled in the art will recognize that it is within the scope of the invention to reverse the configuration such that a continuous protrusion (not shown) extends from the second side 418 and a row of protrusions (not shown) extends from the first side 416.

The artisan will appreciate that the cross-section of the seal (that is, the shape of the generating curve defining the outer surface of the seal) is not critical to the present invention.

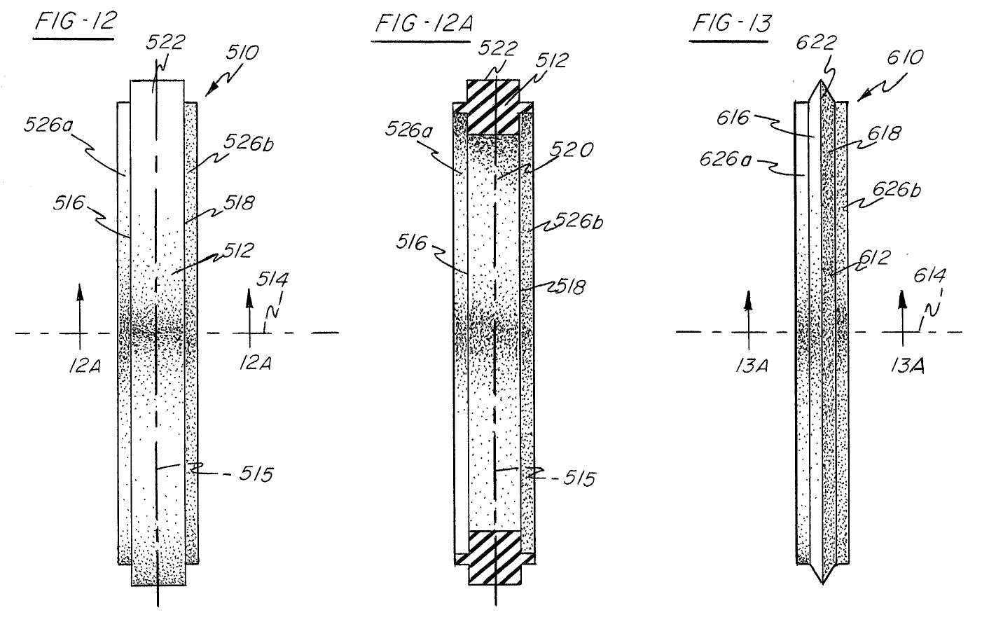

FIGS. 12 and 12A show a seal 510 (FIG. 12) which defines a generally annular body portion 512; a central axis 514 (FIG. 12); a radial plane 515; first and second sides 516 and 518; and inner and outer diameter sides 520 (FIG. 12A) and 522. Unlike the seals 10, 110, 210, 310 and 410 shown in FIGS. 1-11, the cross-section of body portion 512 is square rather than circular. Continuous protrusions 526a and 526b are disposed about the central axis 514 (FIG. 12) and extend outwardly from the first and second sides 516, 518. Most preferably, the protrusions 526a, 526b each comprise a substantially rectangular flange or wall extending from the first and second sides 516, 518 perpendicularly to the radial plane 515. Those skilled in the art will recognize that it is within the scope of the invention to employ a single protrusion (not shown) extending from either the first side 516 or the second side 518.

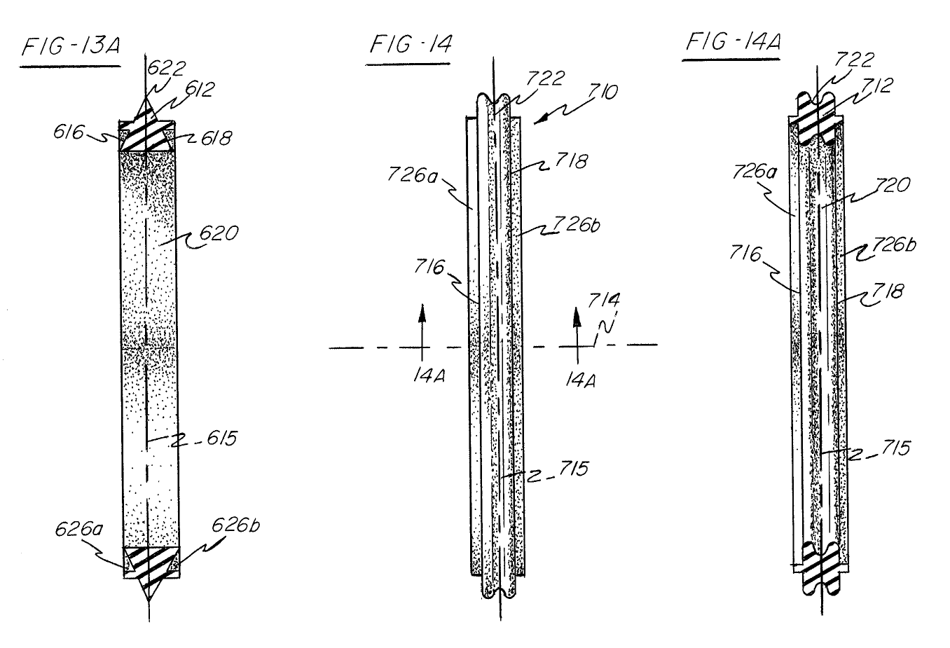

FIGS. 13 and 13A show another seal 610 (FIG. 13) defining a generally annular body portion 612; a central axis 614 (FIG. 13); a radial plane 615 (FIG. 13A); first and second sides 616 and 618; and inner and outer diameter sides 620 (FIG. 13A) and 622. The cross-section of body portion 612 is triangular. Continuous protrusions 626a and 626b are disposed about the central axis 614 (FIG. 13) and extend outwardly from the first and second sides 616, 618. Most preferably, the protrusions 626a, 626b each comprise a substantially rectangular flange or wall extending from the first and second sides 616, 618 perpendicularly to the radial plane 615 (FIG. 13A). Those skilled in the art will recognize that it is within the scope of the invention to employ a single protrusion (not shown) extending from either the first side 620 (FIG. 13A) or the second side 622.

FIGS. 14 and 14A show yet another seal 710 (FIG. 14) which defines a generally annular body portion 712; a central axis 714 (FIG. 14); a radial plane 715; first and second sides 716 and 718; and inner and outer diameter sides 720 (FIG. 14A) and 722. The cross-section of body portion 712 is hour-glass-shaped. Continuous protrusions 726a and 726b are disposed about the central axis 714 (FIG. 14) and extend outwardly from the first and second sides 716, 718. Most preferably, the protrusions 726a, 726b each comprise a substantially rectangular flange or wall extending from the first and second sides 716, 718 perpendicularly to the radial plane 715. Those skilled in the art will recognize that it is within the scope of the invention to employ a single protrusion (not shown) extending from either the first side 720 or the second side 722.

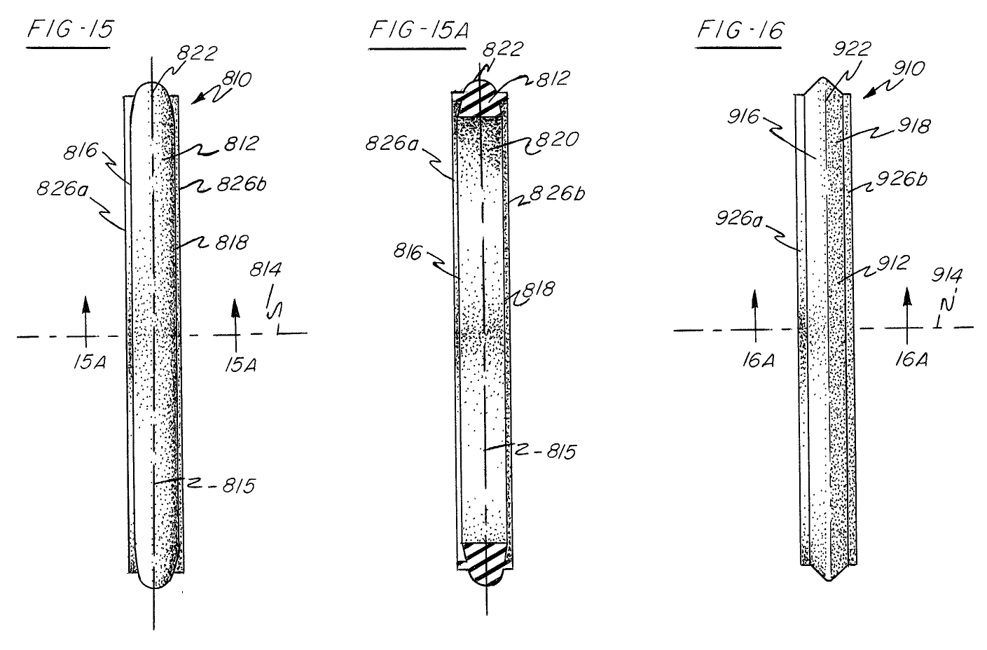

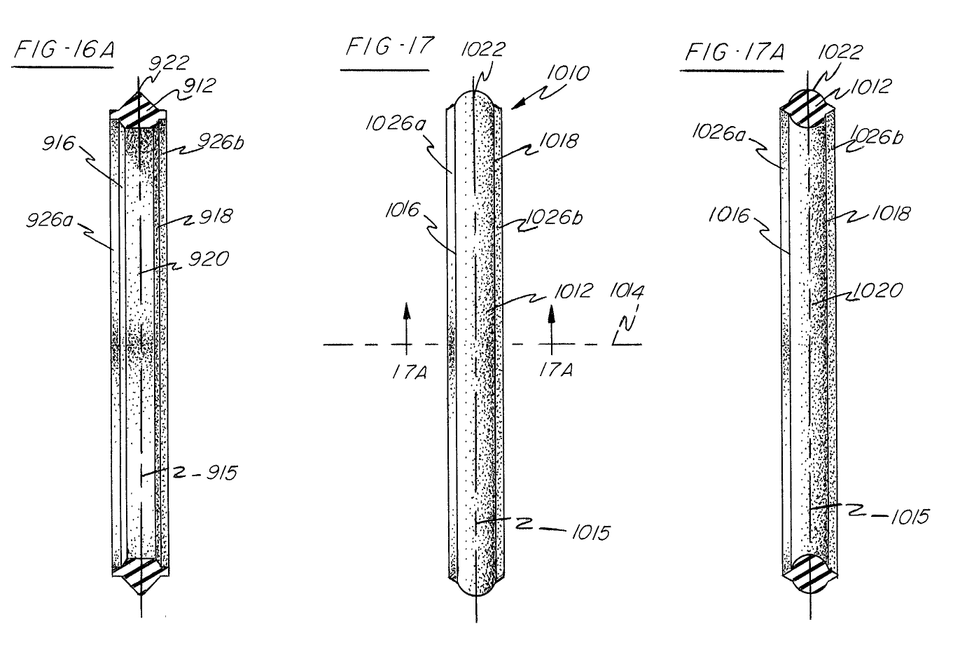

In another embodiment, as shown in FIGS. 15 and 15A, a seal 810 (FIG. 15) defines a generally annular body portion 812; a central axis 814 (FIG. 15); a radial plane 815; first and second sides 816 and 818; and inner and outer diameter sides 820 (FIG. 15A) and 822. The cross-section of body portion 812 is bullet-shaped. Continuous protrusions 826a and 826b are disposed about the central axis 814 (FIG. 15) and extend outwardly from the first and second sides 816, 818. Most preferably, the protrusions 826a, 826b each comprise a substantially rectangular flange or wall extending from the first and second sides 816, 818 perpendicularly to the radial plane 815. Those skilled in the art will recognize that it is within the scope of the invention to employ a single protrusion (not shown) extending from either the first side 820 (FIG. 15A) or the second side 822.

FIGS. 16 and 16A show still another seal 910 (FIG. 16) which defines a generally annular body portion 912; a central axis 914 (FIG. 16); a radial plane 915 (FIG. 16A); first and second sides 916 and 918; and inner and outer diameter sides 920 and 922. The cross-section of body portion 912 is pentagonal. Continuous protrusions 926a and 926b are disposed about the central axis 914 (FIG. 16) and extend outwardly from the first and second sides 916, 918. Most preferably, the protrusions 926a, 926b each comprise a substantially rectangular flange or wall extending from the first and second sides 916, 918 perpendicularly to the radial plane 915 (FIG. 16A). Those skilled in the art will recognize that it is within the scope of the invention to employ a single protrusion (not shown) extending from either the first side 920 (FIG. 16A) or the second side 922.

The artisan will appreciate that the configuration of the one or more protrusions is not critical to the present invention. While this will be illustrated by examples having generally toroidal body portions with round cross-sections, those skilled in the art will appreciate that it is within the scope of the invention to combine non-rectangular protrusions with body portions which are not annular or with body portions having non-circular cross-sections.

FIGS. 17 and 17A show a seal 1010 (FIG. 17) which defines a generally annular body portion 1012; a central axis 1014 (FIG. 17); a radial plane 1015; first and second sides 1016 and 1018; and inner and outer diameter sides 1020 (FIG. 17A) and 1022. The cross-section of body portion 1012 is circular. Continuous protrusions 1026a and 1026b are disposed about the central axis 1014 (FIG. 17) and extend outwardly from the first and second sides 1016, 1018. Most preferably, the protrusions 1026a, 1026b each comprise a substantially triangular flange extending from the first and second sides 1016, 1018 perpendicularly to the radial plane 1015.

FIGS. 18 and 18A show another seal 1110 (FIG. 18) which defines a generally annular body portion 1112; a central axis 1114 (FIG. 18); a radial plane 1115; first and second sides 1116 and 1118; and inner and outer diameter sides 1120 (FIG. 18A) and 1122. Continuous protrusions 1126a and 1126b are disposed about the central axis 1114 (FIG. 18) and extend outwardly from the first and second sides 1116, 1118. Most preferably, the protrusions 1126a, 1126b each comprise a curved or bullet-shaped flange extending from the first and second sides 1116, 1118 perpendicularly to the radial plane 1115.

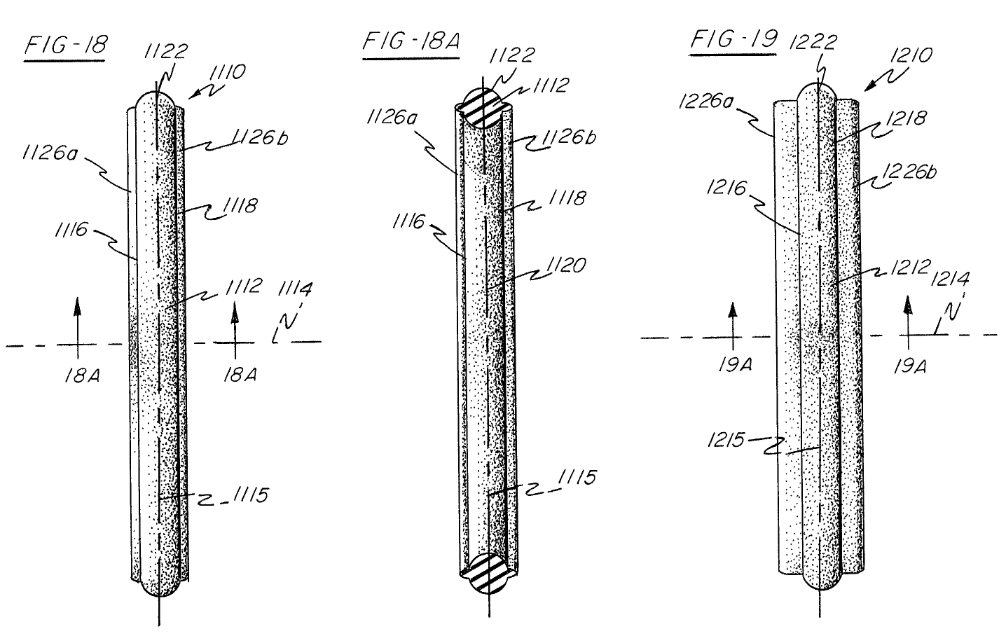

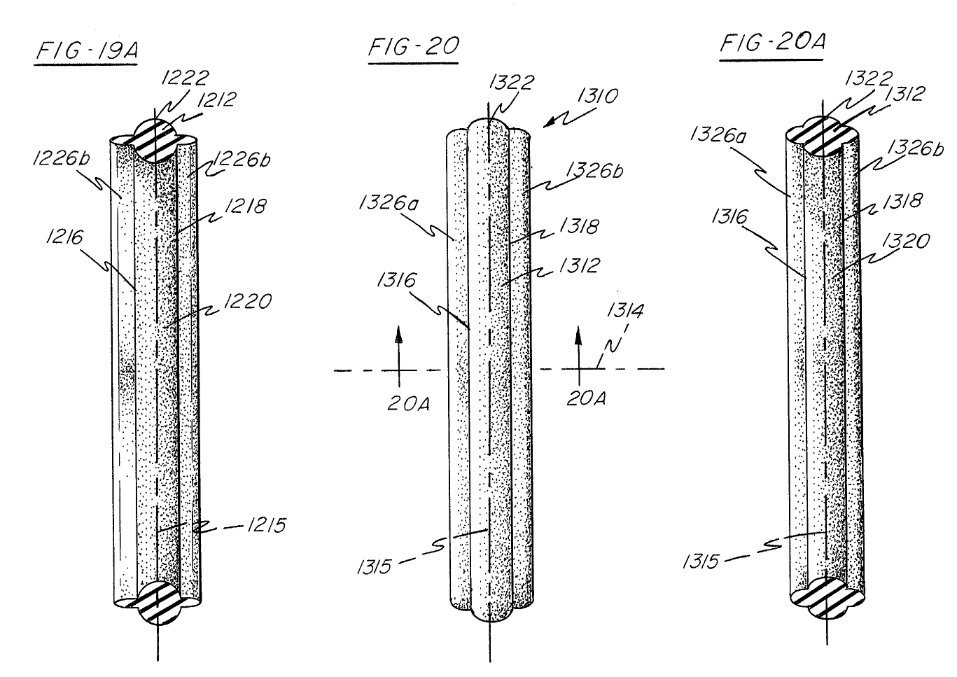

FIGS. 19 and 19A show yet another seal 1210 (FIG. 19) which defines a generally annular body portion 1212; a central axis 1214 (FIG. 19); a radial plane 1215; first and second sides 1216 and 1218; and inner and outer diameter sides 1220 (FIG. 19) and 1222. Continuous protrusions 1226a and 1226b are disposed about the central axis 1214 (FIG. 19) and extend outwardly from the first and second sides 1216, 1218. Most preferably, the protrusions 1226a, 1226b each comprise a curved or bullet-shaped flange extending from the first and second sides 1216, 1218 perpendicularly to the radial plane 1215. Those skilled in the art will appreciate from a comparison of the protrusions 1126a, 1126b of FIGS. 18 and 18A with the protrusions 1226a, 1226b of FIGS. 19 and 19A that the distances through which the protrusions extend from the surfaces of the seals are not critical to the invention but rather are matters of design choice.

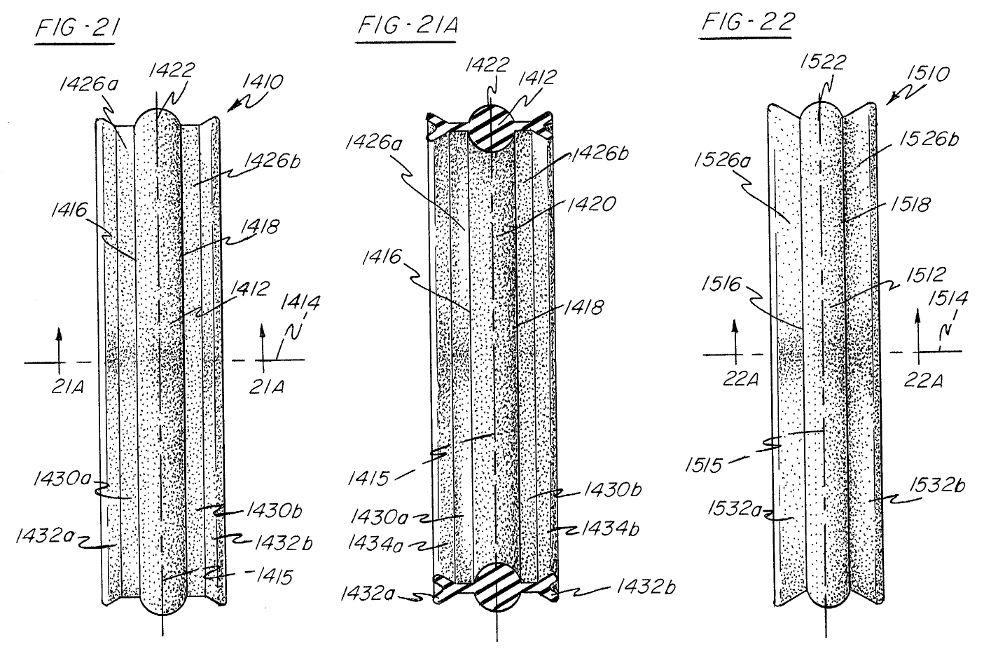

In another embodiment, shown in FIGS. 20 and 20A, a seal 1310 (FIG. 20) defines a generally annular body portion 1312; a central axis 1314 (FIG. 20); a radial plane 1315; first and second sides 1316 and 1318; and inner and outer diameter sides 1320 (FIG. 20A) and 1322. Continuous protrusions 1326a and 1326b are disposed about the central axis 1314 (FIG. 20) and extend outwardly from the first and second sides 1316, 1318. Most preferably, the protrusions 1326a, 1326b each comprise a curved or bullet-shaped flange extending from the first and second sides 1316, 1318 perpendicularly to the radial plane 1315. Those skilled in the art will appreciate from a comparison of the protrusions 1126a, 1126b of FIGS. 18 and 18A with the protrusions 1326a, 1326b of FIGS. 20 and 20A that the widths of the protrusions are not critical to the invention but rather are matters of design choice.

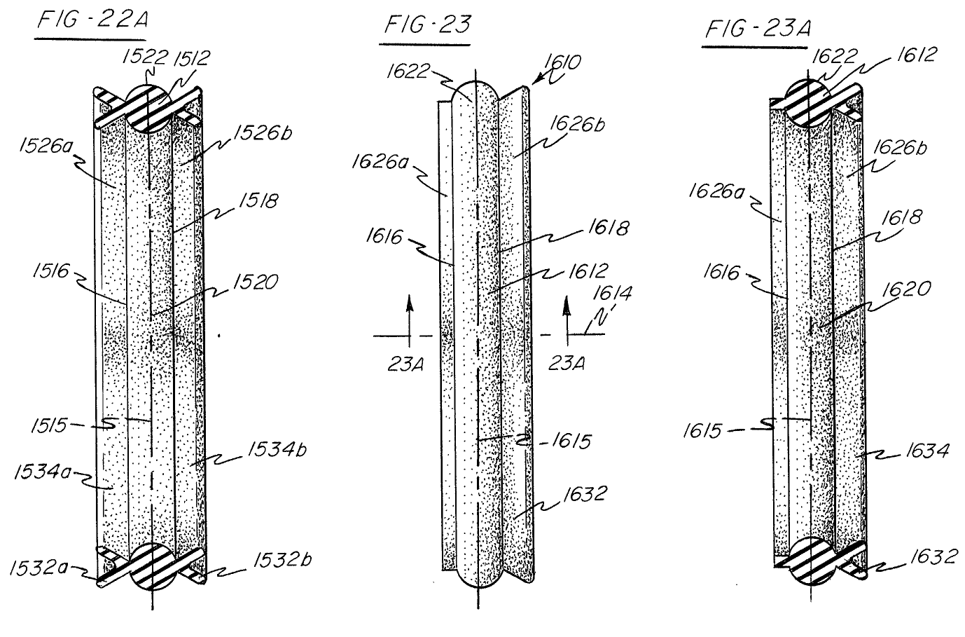

FIGS. 21 and 21A show still another seal 1410 (FIG. 21) which defines a generally annular body portion 1412; a central axis 1414 (FIG. 21); a radial plane 1415; first and second sides 1416 and 1418; and inner and outer diameter sides 1420 (FIGS. 21A) and 1422. Continuous protrusions 1426a and 1426b are disposed about the central axis 1414 (FIG. 21) and extend outwardly from the first and second sides 1416, 1418. Most preferably, the protrusions 1426a, 1426b each comprise “Y”-shaped flanges extending from the first and second sides 1416, 1418 perpendicularly to the radial plane 1415. More specifically, the protrusion 1426a comprises three components, an axial component 1430a extending from the first side 1416 perpendicularly to the radial plane 1415; a first oblique component 1432a extending from the axial component 1430a obliquely to the radial plane 1415; and a second oblique component 1434a (FIG. 21A) extending from the axial component 1430a obliquely to the radial plane 1415. Likewise, the protrusion 1426b comprises an axial component 1430b, a first oblique component 1432b and a second oblique component 1434b (FIG. 21A). 101051 FIGS. 22 and 22A show yet another seal 1510 (FIG. 22) which defines a generally annular body portion 1512; a central axis 1514 (FIG. 22); a radial plane 1515; first and second sides 1516 and 1518; and inner and outer diameter sides 1520 (FIG. 22A) and 1522. Continuous protrusions 1526a and 1526b are disposed about the central axis 1514 (FIG. 22) and extend outwardly from the first and second sides 1516, 1518. Most preferably, the protrusions 1526a, 1526b each comprise “V”-shaped flanges extending from the first and second sides 1516, 1518 transversely to the radial plane 1515. More specifically, the protrusion 1526a comprises oblique components 1532a and 1534a (FIG. 22A) extending from the first side 1516 obliquely to the radial plane 1515. Likewise, the protrusion 1526b comprises a first oblique component 1532b and a second oblique component 1534b (FIG. 22A).

FIGS. 23 and 23A show still another seal 1610 (FIG. 23) which defines a generally annular body portion 1612; a central axis 1614 (FIG. 23A); a radial plane 1615; first and second sides 1616 and 1618; and inner and outer diameter sides 1620 (FIG. 23A) and 1622. Continuous protrusions 1626a and 1626b are disposed about the central axis 1614 (FIG. 23) and extend outwardly from the first and second sides 1616, 1618. Most preferably, the protrusion 1626a comprises a substantially rectangular flange or wall extending from the first side 1616 perpendicularly to the radial plane 1615. The protrusion 1626b comprises a “V”-shaped flange extending from the second side 1618 transversely to the radial plane 1615. More specifically, the protrusion 1626a comprises two oblique components 1632 and 1634 (FIG. 23A) extending from the second side 1618 obliquely to the radial plane 1615.

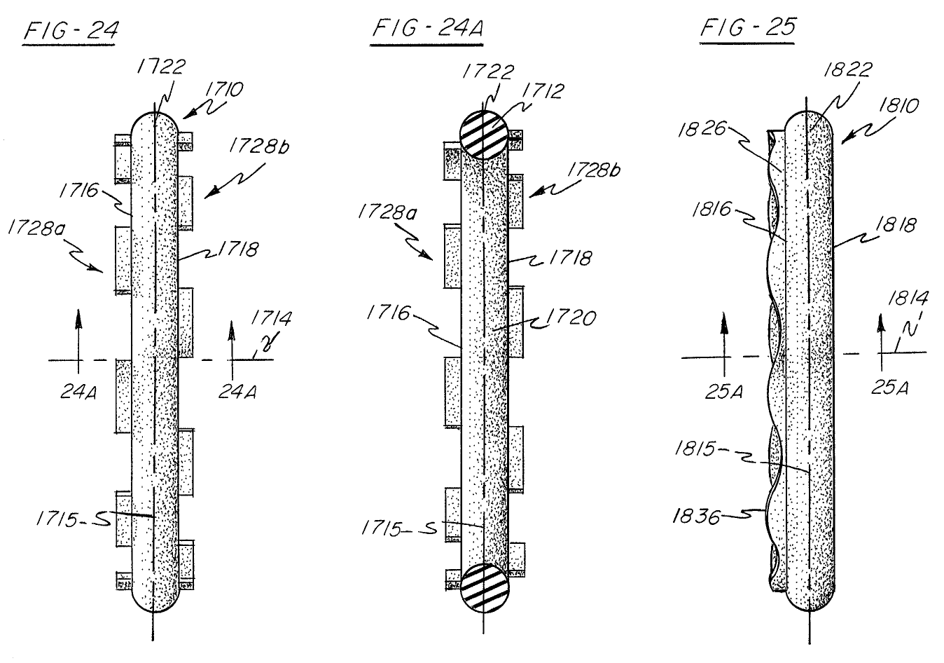

In another embodiment, shown in FIGS. 24 and 24A, a seal 1710 (FIG. 24) defines a body portion 1712; a central axis 1714 (FIG. 24); a radial plane 1715; first and second sides 1716 and 1718; and inner and outer diameter sides 1720 (FIG. 24A) and 1722. Rows or annular arrays of spaced-apart protrusions 1728a and 1728b are disposed about the central axis 1714 (FIG. 24) and extend outwardly from the first and second sides 1716, 1718. Most preferably, each row of protrusion 1728a, 1728b comprises a row of crenellated, rectangular flanges or walls extending from the first and second sides 1716, 1718 perpendicularly to the radial plane 1715. Those skilled in the art will appreciate from a comparison of the rows of protrusions 328a, 328b of FIGS. 8 and 9 with the rows of protrusions 1728a, 1728b of FIGS. 24 and 24A that the sizes and spacings of the crenellated flanges making up the rows are not critical to the invention but rather are matters of design choice.

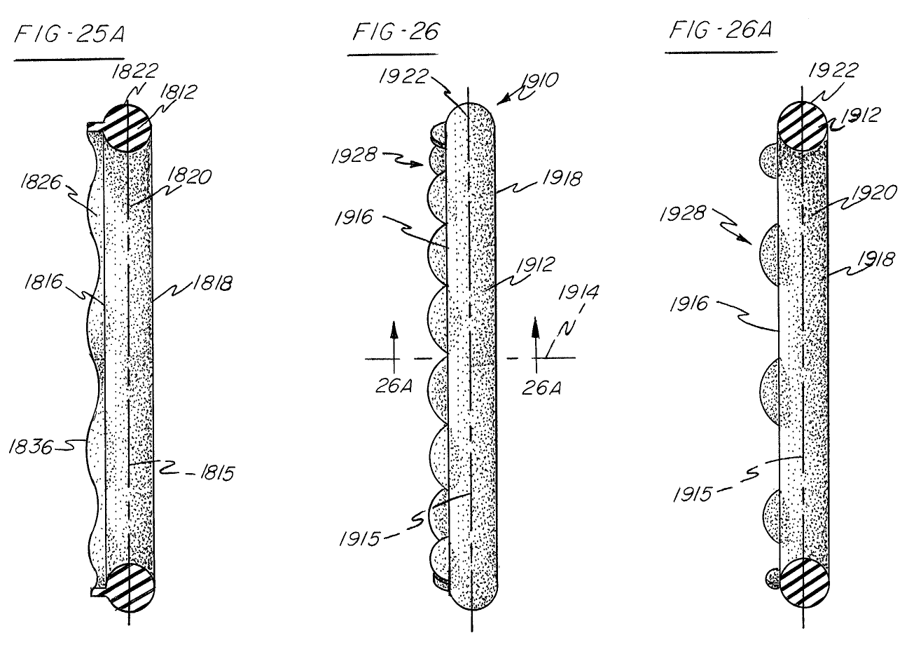

In FIGS. 25 and 25A, a seal 1810 (FIG. 25) defining a body portion 1812; a central axis 1814 (FIG. 25); a radial plane 1815; first and second sides 1816 and 1818; and inner and outer diameter sides 1820 (FIG. 25A) and 1822. A continuous protrusion 1826 is disposed about the central axis 1814 (FIG. 25) and extends outwardly from the first side 1816. Most preferably, the protrusion 1826 comprises a rectangular flange or wall extending from the first side 1816 in a direction perpendicular to the radial plane 1815. The rectangular flange or wall defines an axial surface 1836 which describes an undular or scalloped pattern. Those skilled in the art will recognize that it is within the scope of the invention to employ a similar protrusion (not shown) extending from the second side 1818, alone or in combination with the protrusion 1826 extending from the first side 1816.

FIGS. 26 and 26A show another seal 1910 (FIG. 26) defining a body portion 1912; a central axis 1914 (FIG. 26); a radial plane 1915; first and second sides 1916 and 1918; and inner and outer diameter sides 1920 (FIG. 26A) and 1922. A row or annular array of spaced-apart protrusions 1928 is disposed about the central axis 1914 (FIG. 26) and extend outwardly from the first side 1916. Most preferably, the row of protrusion 1928 comprises a row of periodic, disc-shaped flanges extending from the first side 1916 in a direction perpendicular to the radial plane 1915. Those skilled in the art will recognize that it is within the scope of the invention to employ a similar row of protrusions (not shown) extending from the second side 1918, alone or in combination with the row of protrusions 1928 extending from the first side 1916.

The artisan will appreciate that the position from which the one or more protrusions extend from the body portion of the seal is not critical to the present invention. While this will be illustrated by examples having protrusions comprising rectangular flanges or walls, those skilled in the art will appreciate that the invention is not limited to seals having protrusions of such configurations.

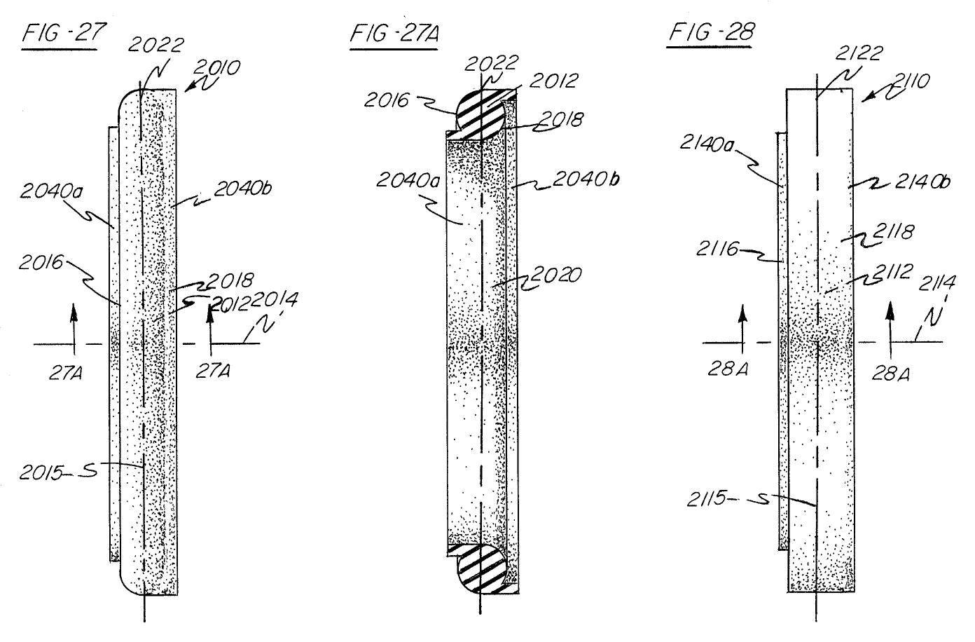

In one embodiment, as shown in FIGS. 27 and 27A, a seal 2010 (FIG. 27) defines a body portion 2012; a central axis 2014 (FIG. 27); a radial plane 2015; first and second sides 2016 and 2018; and inner and outer diameter sides 2020 (FIG. 27A) and 2022. The body portion 2012 has a circular cross-section. Continuous protrusions 2040a and 2040b are disposed about the central axis 2014 (FIG. 27) and extend tangentially from the inner and outer surfaces 2020 (FIG. 27A), 2022. Most preferably, the protrusions 2040a, 2040b each comprise a rectangular flange or wall extending from the inner and outer surfaces 2020 (FIG. 27A), 2022 perpendicularly to the radial plane 2015. Those skilled in the art will recognize that it is within the scope of the invention to employ a pair of similar protrusions (not shown), each extending in opposite orientations from either the inner surface 2020 (FIG. 27A) or the outer surface 2022.

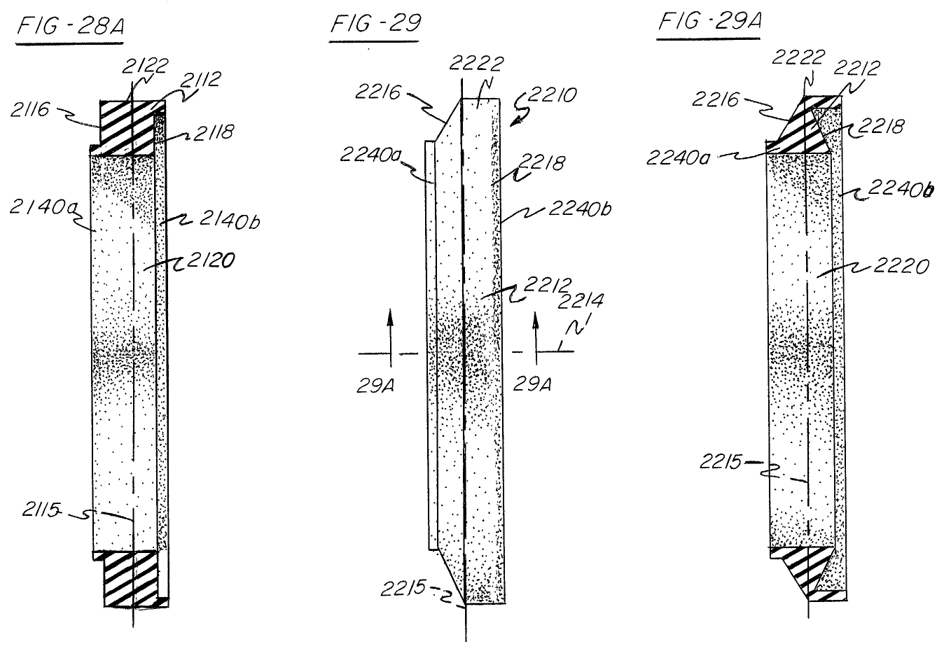

FIGS. 28 and 28A show a seal 2110 (FIG. 28) defining a body portion 2112; a central axis 2114 (FIG. 28); a radial plane 2115; first and second sides 2116 and 2118; and inner and outer diameter sides 2120 (FIG. 28A) and 2122. The body portion 2112 has a square cross-section. Continuous protrusions 2140a and 2140b are disposed about the central axis 2114 (FIG. 28) and extend tangentially from the inner and outer surfaces 2120 (FIG. 28A), 2122. Most preferably, the protrusions 2140a, 2140b each comprise a rectangular flange or wall extending from the inner and outer surfaces 2120 (FIG. 28A), 2122 perpendicularly to the radial plane 2115. Those skilled in the art will recognize that it is within the scope of the invention to employ a pair of similar protrusions (not shown), each extending in opposite orientations from either the inner surface 2120 (FIG. 28A) or the outer surface 2122.

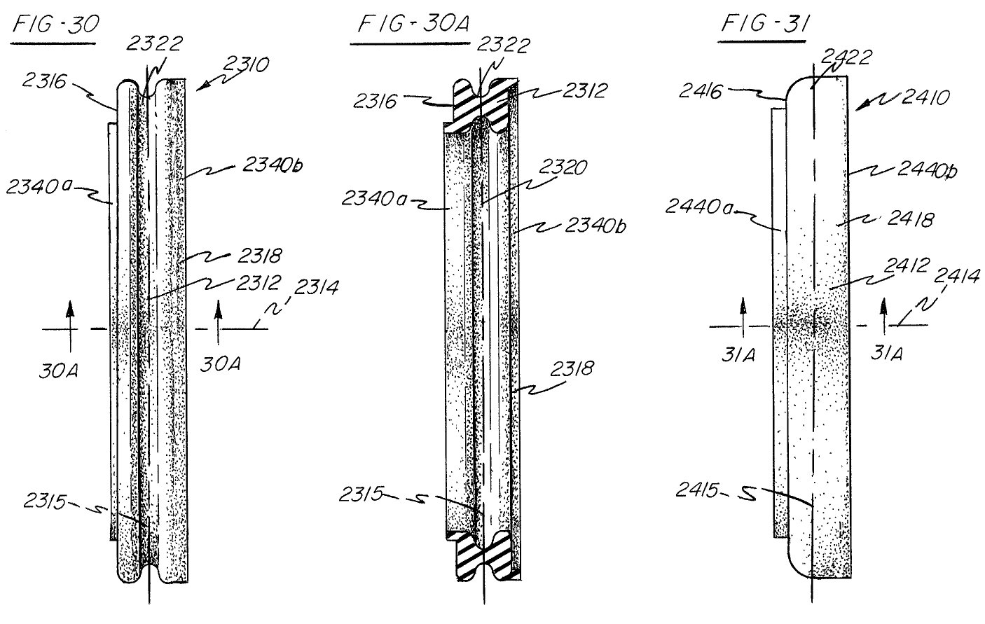

FIGS. 29 and 29A show another seal 2210 (FIG. 29) defining a body portion 2212; a central axis 2214 (FIG. 29); a radial plane 2215; first and second sides 2216 and 2218; and inner and outer diameter sides 2220 (FIG. 29A) and 2222. The body portion 2212 has a triangular cross-section. Continuous protrusions 2240a and 2240b are disposed about the central axis 2214 and extend tangentially from the inner and outer surfaces 2220 (FIG. 29A), 2222. Most preferably, the protrusions 2240a, 2240b each comprise a rectangular flange or wall extending from the inner and outer surfaces 2220 (FIG. 29A), 2222 perpendicularly to the radial plane 2215. Those skilled in the art will recognize that it is within the scope of the invention to employ a pair of similar protrusions (not shown), each extending in opposite as orientations from either the inner surface 2220 (FIG. 29A) or the outer surface 2222.

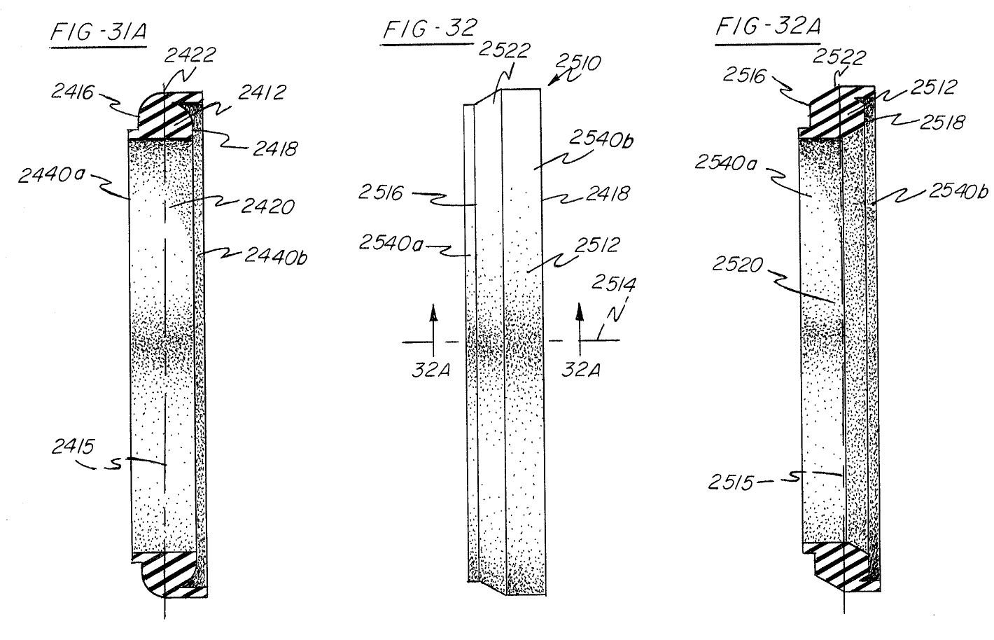

FIGS. 30 and 30A show yet another seal 2310 (FIG. 30) which defines a body portion 2312; a central axis 2314 (FIG. 30); a radial plane 2315; first and second sides 2316 and 2318; and inner and outer diameter sides 2320 (FIG. 30A) and 2322. The body portion 2312 has an hour-glass-shaped cross-section. Continuous protrusions 2340a and 2340b are disposed about the central axis 2314 (FIG. 30) and extend tangentially from the inner and outer surfaces 2320 (FIG. 30A), 2322. Most preferably, the protrusions 2340a, 2340b each comprise a rectangular flange or wall extending from the inner and outer surfaces 2320 (FIG. 30A), 2322 perpendicularly to the radial plane 2315. Those skilled in the art will recognize that it is within the scope of the invention to employ a pair of similar protrusions (not shown), each extending in opposite orientations from either the inner surface 2320 (FIG. 30A) or the outer surface 2322.

In another embodiment shown in FIGS. 31 and 31A, a seal 2410 (FIG. 31) defines a body portion 2412; a central axis 2414 (FIG. 31); a radial plane 2415; first and second sides 2416 and 2418; and inner and outer diameter sides 2420 (FIG. 31A) and 2422. The body portion 2412 has a bullet-shaped cross-section. Continuous protrusions 2440a and 2440b are disposed about the central axis 2414 (FIG. 31) and extend tangentially from the inner and outer surfaces 2420 (FIG. 31 A), 2422. Most preferably, the protrusions 2440a, 2440b each comprise a rectangular flange or wall extending from the inner and outer surfaces 2420 (FIG. 31A), 2422 perpendicularly to the radial plane 2415. Those skilled in the art will recognize that it is within the scope of the invention to employ a pair of similar protrusions (not shown), each extending in opposite orientations from either the inner surface 2420 (FIG. 31A) or the outer surface 2422.

FIGS. 32 and 32A show a seal 2510 (FIG. 32) defining a body portion 2512; a central axis 2514 (FIG. 32); a radial plane 2515 (FIG. 32A); first and second sides 2516 and 2518; and inner and outer diameter sides 2520 (FIG. 32A) and 2522. The body portion 2512 has a hexagonal cross-section. Continuous protrusions 2540a and 2540b are disposed about the central axis 2514 (FIG. 32) and extend tangentially from the inner and outer surfaces 2520 (FIG. 32A), 2522. Most preferably, the protrusions 2540a, 2540b each comprise a rectangular flange or wall extending from the inner and outer surfaces 2520 (FIG. 32A), 2522 perpendicularly to the radial plane 2515 (FIG. 32A). Those skilled in the art will recognize that it is within the scope of the invention to employ a pair of similar protrusions (not shown), each extending in opposite orientations from either the inner surface 2520 (FIG. 32A) or the outer surface 2522.

The artisan will appreciate that the shape of the directing curve which defines the configuration of the body portion is not critical to the present invention.

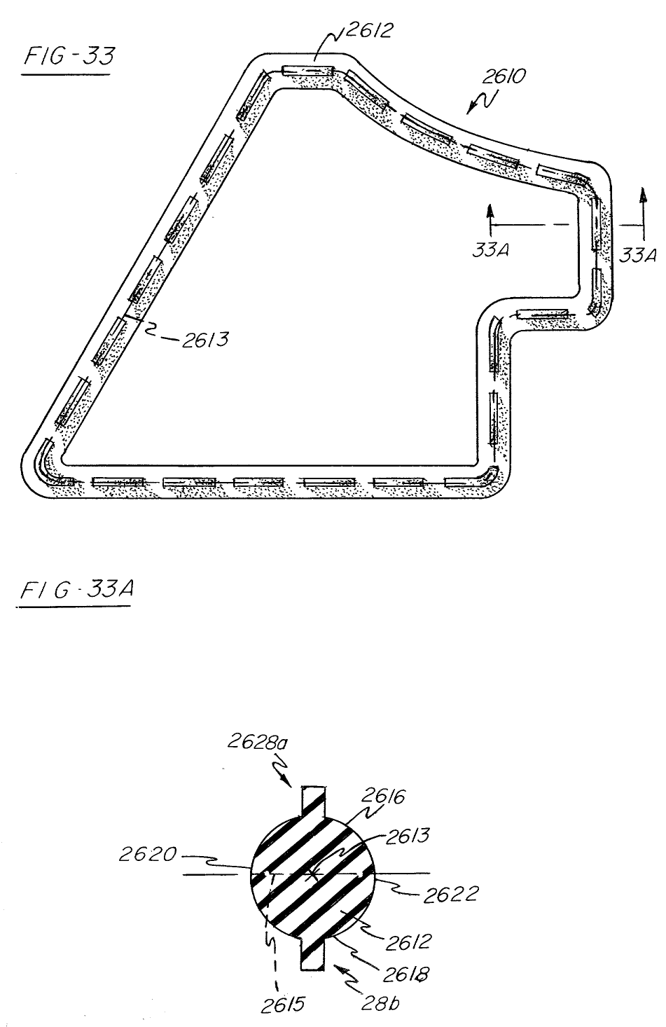

For example, FIG. 33 shows a seal 2610 (FIG. 33) defining a body portion 2612 and a planar directing curve 2613. As illustrated in FIG. 33A, the seal 2610 (FIG. 33) further defines a radial plane 2615 (FIG. 33A) containing the directing curve 2613; first and second sides 2616 (FIG. 33A) and 2618 (FIG. 33A); and inner and outer diameter sides 2620 (FIG. 33A) and 2622 (FIG. 33A). Since the directing curve 2613 is planar, the normal direction (not shown) within each cross-section plane (not shown) lies along the radial plane 2615 (FIG. 33A). Rows or annular array of spaced-apart protrusions 2628a and 2628b (FIG. 33A) are disposed along the directing curve 2613 and extend outwardly from the first and second sides 2616, 2618 (FIG. 33A). Most preferably, each row of protrusion 2628a, 2628b (FIG. 33A) comprises a row of crenellated, rectangular flanges or walls extending from the first and second sides 2616, 2618 (FIG. 33A) perpendicularly to the radial plane 2615 (FIG. 33A).

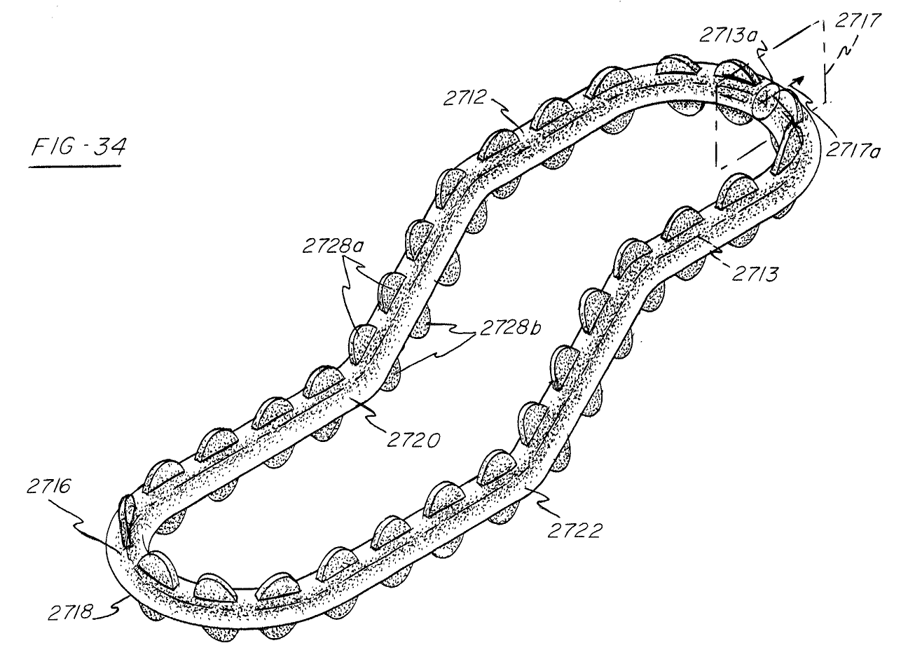

FIG. 34 shows another seal 2710 defining a body portion 2712. The shape of the body portion 2712 is substantially that derived by propagating a generating circle 2713a along a non-planar directing curve 2713. The directing curve 2713 defines a plurality of cross-sectional planes 2717 (only one shown in FIG. 34) and a normal direction 2717a (only one shown in FIG. 34) in each of these cross-sectional planes 2717. The cross-section of the body portion 2712 taken along each cross-sectional plane 2717 has substantially the same shape as the generating circle 2713a.

The seal 2710 further defines first and second sides or surface quadrants 2716 and 2718 which are disposed on opposite sides of the directing curve 2713; and inner and outer diameter sides 2720 and 2722 opposed along the normal directions 2717a (only one shown in FIG. 34) so as to separate the first and second sides 2716, 2718. Rows or annular arrays of spaced-apart protrusions 2728a and 2728b are disposed along the directing curve 2713 and extend outwardly from the first and second sides 2716, 2718. Most preferably, each row of protrusions 2728a, 2728b comprises a row of spaced-apart flanges extending from the first and second sides 2716, 2718 perpendicularly to the normal directions 2717a defined at each point along the directing curve 2713.

The configurations of the preferred embodiments serve to resist twisting of the seals during placement and use. Certain objects and advantages of the preferred seals will be described with specific reference to seal 210 shown in FIGS. 6-7 and to seal 310 shown in FIGS. 8-9. Those skilled in the art will recognize that these objects and advantages are not limited to the particular embodiment shown in FIGS. 6-7 and FIGS. 8-9. Nevertheless, it will be recognized that the appended claims, and not the particular objects and advantages explicitly described herein, define the invention.

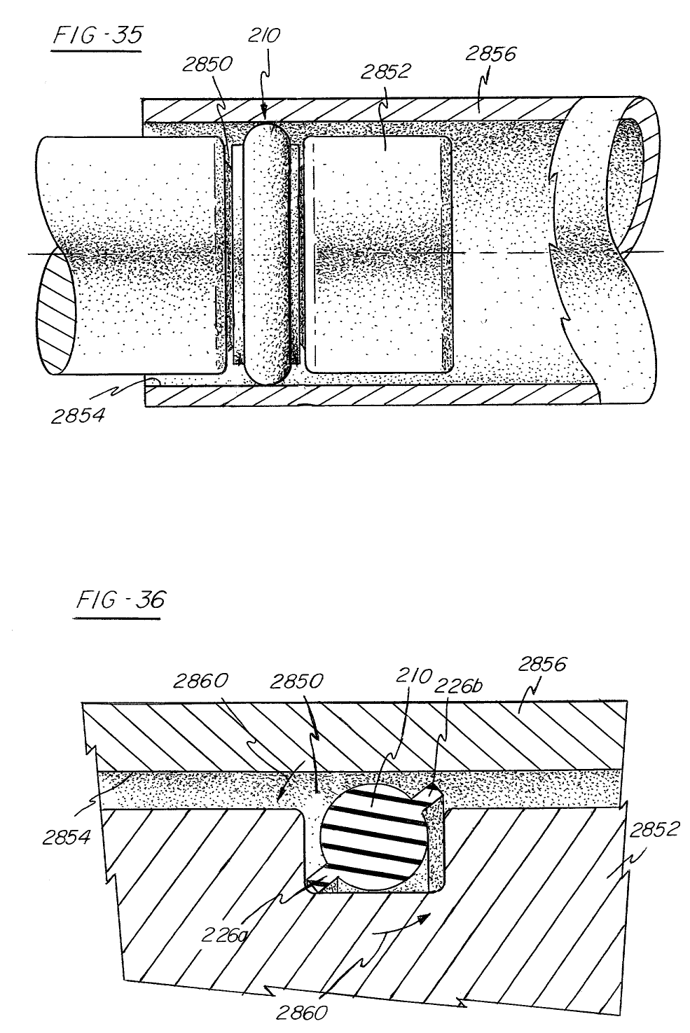

FIG. 35 shows the seal 210 of FIG. 6 positioned in an annular groove 2850 on an outer surface of a shaft 2852 inserted into a bore 2854 in a sleeve 2856 or the like. During assembly, the seal 210 is slid over the outer surface of the shaft 2852 toward the groove 2850. As shown in FIG. 36, the seal 210 is subject to forces tending to twist it in the direction suggested by the arrows 2860 as the seal 210 is slid over the outer surface of the shaft 2852 and then the shaft 2852 is inserted into the bore 2854 in the sleeve 2856 or the like.

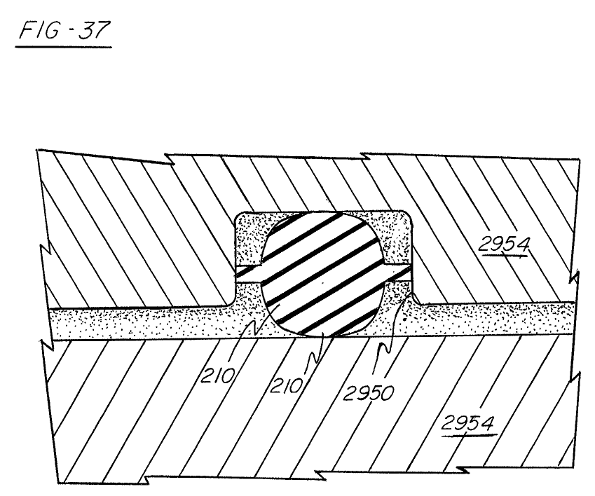

Although FIGS. 35 and 36 show the seal 210 used to seal a gap between a shaft 2852 and a surrounding bore 2854, the invention is not limited to such use. FIG. 37 shows the seal 210 of FIG. 6 inserted into an annular raceway 2950 in a sleeve 2954 or the like partially enclosing a shaft 29529 instead of being positioned in an annular groove (not shown) around the shaft 2952. During assembly, the seal 210 is pressed into the annular raceway 2950 before the shaft 2952 is inserted into the bore 2954. Alternatively, the seal 210 is susceptible of use as a press-in-place perimeter seal. Notably, the present invention is not dependent on being stretched over a shaft 2852 (FIG. 36) to function properly.

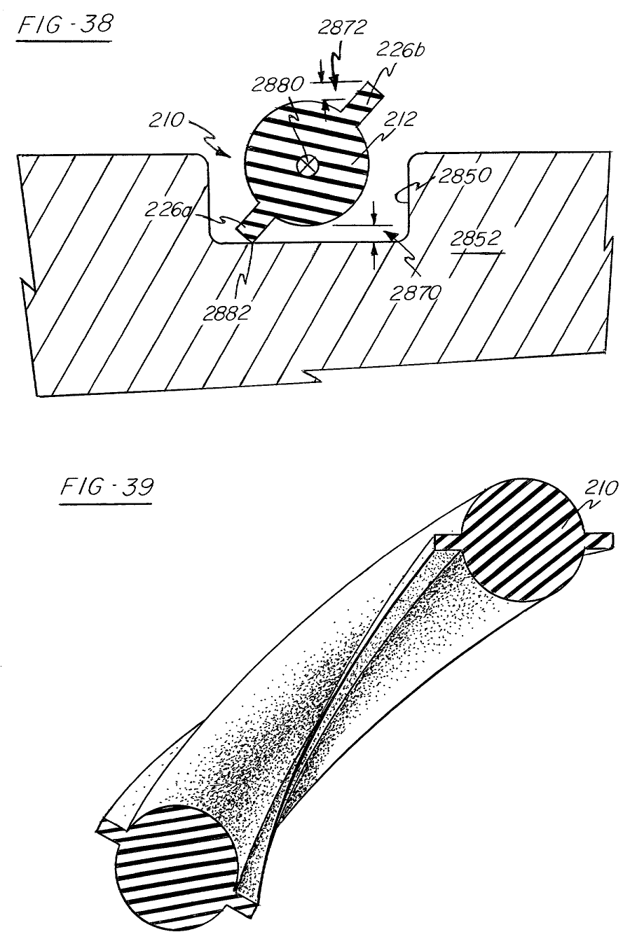

As the seal 210 is twisted with respect to a relaxed, properly-assembled state, the effective thickness of the seal 210 increases, as suggested at 2870 and 2872 in FIG. 38, due to the geometry of the protrusions 226a, 226b. More specifically, it is believed that the effective outer diameter of the seal 210 in its twisted state is greater than the outer diameter of the seal 210 at rest and the effective inner diameter of the seal 210 at rest. This limits twisting of the seal 210 as the seal 210 is slid over the outer surface of the shaft 2852. Additionally, it is believed that the seal 21 0 is subject to hysteresis or “memory” that tends to relieve any twisting of the seal 210 which may occur as the seal 210 is slid over the outer surface of the shaft 2852.

It is also believed that the configuration of the seal 210 significantly increases the shear force required to twist the seal beyond a limit set by the configuration of the protrusions 226a, 226b. As suggested in FIG. 38, the seal 210 tends to twist about an effective center of rotation 2880 during assembly. When the seal 210 twists sufficiently so as to bring one of the protrusions (identified as 226a in FIG. 38) into contact with the inner surface of the groove 2850, as at 2882, the protrusion 226a contacting the inner surface of the groove 2850 inhibits the further twisting of the seal 210 about the center of rotation 2880. Then, it is believed that any further twisting of the seal 210 will occur about an effective center of rotation at or near the point of contact 2882 between the protrusion 226a and the inner surface of the groove 2850. Significantly greater shear force would be required to twist the seal about the point of contact 2882 rather than the original effective center of rotation 2880 due to the greater moment arm at which such shear force would act. In this way, the body portion 212 of the seal 210 is allowed to remain relatively small in cross-section and still maintain anti-rotation advantages comparable to prior art seals having larger seal cross-sections of similar shape.

The configuration of the seal 210 not only serves to resist twisting, but also facilitates detection of such twisting by visual, tactile, leak testing, insertion force or other conventional detection means. Even if the seal 210 were twisted during insertion of the shaft 2852 into the bore 2854 (FIG. 35 and 36), the configuration of the seal 210 would promote the detection of such twisting by means of simple leak decay or pressurization tests. More specifically, as suggested by FIG. 39, the effective thickness of the seal 210 varies along its length (or more accurately, along its directing circle, which is not shown) as the seal 210 is twisted. Thus, the configuration of the seal 210 facilitates pressurization testing due to the increased susceptibility of those segments (not shown) of the seal 210 having lesser effective thicknesses to leakage. Additionally, the amount of force required to position the seal 210 on the shaft 2852 is indicative of whether the seal 210 has twisted, since a twisted seal 210 requires significantly more insertion force than a properly-assembled seal (not shown) requires.

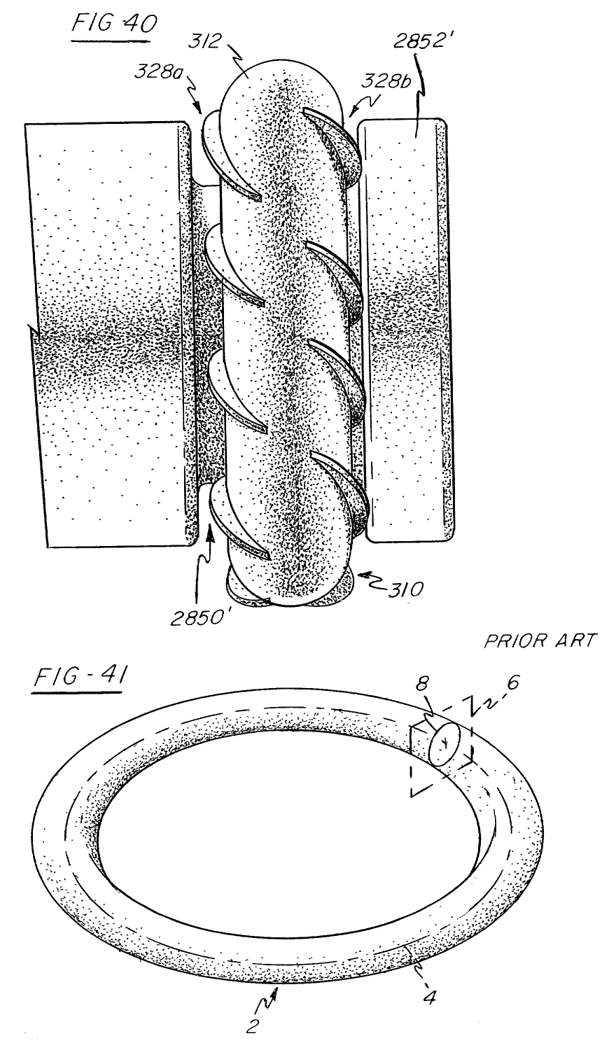

Likewise, the invention facilitates the detection of twisting visually or by touch. FIG. 40 shows the seal 310 of FIG. 8 after being forced into a twisted position around an annular groove 2850′ through the outer surface of a shaft 2852′. The rows of protrusions 328a, 328b form spiral or “candy cane” patterns. These patterns are visible to human eyes (including, it is believed, those of seeing-impaired individuals) and also may be discerned tactilely. It is anticipated that the rows of protrusions 328a, 328b will be so visible that twisting will be easily detected by most commercially available visual and tactile systems (not shown). Furthermore, it is believed that the use of an embodiment such as the seal of FIG. 8 having rows of separate protrusions 328a, 328b would make the use of vision equipment (not shown) more efficient than a seal such as the seal 210 of FIG. 6 having continuous protrusions 326a, 326b (FIG. 6). For example, it is anticipated that accurate go/no-go gages (not shown) will detect an increase in the effective outside diameter of the seal 310 indicative of twisting as the seal 310 passes through it.

The seal 10-2710 of the present invention may be molded, extruded and cut, or otherwise formed in a conventional manner of an elastomeric or other conventional polymeric sealing material which may be selected particularly for compatibility with the fluid being handled. Depending then upon the application, suitable materials include natural rubbers such as hevea, as well as thermoplastic, i.e., melt-processible, or thermosetting, i.e., vulcanizable, synthetic rubbers such as fluoropolymers, chlorosulfonate, polybutadiene, buna-N, butyl, neoprene, nitrile, polyisoprene, silicone, fluorosilicone, copolymer rubbers such as ethylene-propylene (EPR), ethylene-propylene-diene monomer (EPDM), nitrile-butadiene (NBR) and styrene-butadiene (SBR), or blends such as ethylene or propylene-EPDM, EPR, or NB. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used here, the term “elastomeric” is ascribed its conventional meaning of exhibiting rubber-like properties of compliancy, resiliency or compression deflection, low compression set, flexibility and an ability to recover after deformation.

Those skilled in the art will appreciate the additional applications of the present invention that are implied by the merits and features described and shown in the drawings. The use of the invention further is not limited to seals as it will provide equal performance advantages if applied in the manner herein disclosed as a spacer, gasket, damper, isolator, or other molded shaped, or as incorporated into other articles such as a grommet or diaphragm.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A seal comprising a body portion and one or more protrusions extending from said body portion; said body portion defining a directing curve, a generating curve defining a shape and a plurality of cross-sectional planes normal to said directing curve such that cross-sections of said body portion taken along each cross-sectional plane of said plurality of cross-sectional planes have substantially said shape of said generating curve; said one or more protrusions intersecting one or more cross-sectional planes of said plurality of cross-sectional planes and defining one or more components; said directing curve defining a normal direction along each one of said one or more cross-sectional planes such that said one or more components extend along each one of said one or more cross-sectional planes transversely to said normal direction defined along that one of said one or more cross-sectional planes.

2. The seal as recited in claim 1 wherein said shape is selected from the group consisting of circular, triangular, square, pentagonal, hexagonal, hour-glass-shaped and bullet-shaped.

3. The seal as recited in claim 1 wherein said one or more protrusions extend along each one of said one or more cross-sectional planes transversely to said normal direction defined along that one of said one or more cross-sectional planes.

4. The seal as recited in claim 1 wherein said one or more components extend along each one of said one or more cross-sectional planes substantially perpendicularly to said normal direction defined along that one of said one or more cross-sectional planes.

5. The seal as recited in claim 1 wherein said one or more protrusions include a single protrusion continuous along said directing curve.

6. The seal as recited in claim 1 wherein said one or more protrusions include a row of protrusions extending along said directing curve.

7. The seal as recited in claim 1 wherein said one or more protrusions include protrusions extending from opposite sides of said body portion.

8. The seal as recited in claim 1 wherein said body portion defines inner and outer sides opposed along said normal direction; said body portion further defines opposed first and second sides separated by said inner and outer sides; and said one or more protrusions extend from said first side and from said second side.

9. The seal as recited in claim 1 wherein said body portion defines inner and outer sides opposed along said normal direction; and said one or more protrusions extend from one of said inner and outer sides.

10. The seal as recited in claim 1 wherein said body portion defines inner and outer sides opposed along said normal direction; and said one or more protrusions extend from said inner side and from said outer side.

11. A seal comprising a body portion and one or more protrusions extending from said body portion; said body portion defining a radial plane, a directing curve lying in said radial plane, a generating curve defining a shape and a plurality of cross-sectional planes normal to said directing curve such that cross-sections of said body portion taken along each cross-sectional plane of said plurality of cross-sectional planes have substantially said shape of said generating curve; said one or more protrusions intersecting one or more cross-sectional planes of said plurality of cross-sectional planes and defining one or more components such that said one or more components extend along each one of said one or more cross-sectional planes transversely to said radial plane.

12. The seal as recited in claim 11 wherein said shape is selected from the group consisting of circular, triangular, square, pentagonal, hexagonal, hour-glass-shaped and bullet-shaped.

13. The seal as recited in claim 1 wherein said one or more protrusions extend along each one of said one or more cross-sectional planes transversely to said radial plane.

14. The seal as recited in claim 11 wherein said one or more components extend along each one of said one or more cross-sectional planes perpendicularly to said radial plane.

15. The seal as recited in claim 11 wherein said one or more protrusions include a single protrusion continuous along said directing curve.

16. The seal as recited in claim 11 wherein said one or more protrusions include a row of protrusions extending along said directing curve.

17. The seal as recited in claim 11 wherein said one or more protrusions include protrusions extending from opposite sides of said body portion.

18. The seal as recited in claim 11 wherein said body portion defines inner and outer sides opposed along said normal direction; said body portion further defines opposed first and second sides separated by said inner and outer sides; and said one or more protrusions extend from said first side and from said second side.

19. The seal as recited in claim 11 wherein said body portion defines inner and outer sides opposed along said normal direction; and said one or more protrusions extend from one of said inner and outer sides.

20. The seal as recited in claim 11 wherein said body portion defines inner and outer sides opposed along said normal direction; and said one or more protrusions extend from said inner side and from said outer side.

21. A seal comprising an annular body portion defining a radial plane and one or more protrusions extending from said annular body portion transversely to said radial plane.

22. The seal as recited in claim 21 wherein said shape is selected from the group consisting of circular, triangular, square, pentagonal, hexagonal, hour-glass-shaped and bullet-shaped.

23. A method for sealing a shaft in a bore comprising the steps of:
a) providing an annular groove through a surface of one of said shaft and said bore;
b) forcing into said annular groove a seal comprising a body portion and one or more protrusions extending from said body portion, said body portion defining a directing curve, a generating curve defining a shape and a plurality of cross-sectional planes normal to said directing curve such that cross-sections of said body portion taken along each cross-sectional plane of said plurality of cross-sectional planes have substantially said shape of said generating curve, said one or more protrusions intersecting one or more cross-sectional planes of said plurality of cross-sectional planes and defining one or more components, and said directing curve defining a normal direction along each one of said one or more cross-sectional plane such that said one or more components extend along each one of said one or more cross-sectional planes transversely to said normal direction defined along that one of said one or more cross-sectional planes; and
c) inserting said shaft into said bore so that said seal engages said shaft and said bore.

24. The method as recited in claim 23 wherein said step a) includes providing said bore through a surface of said shaft.

25. The method as recited in claim 23 wherein said step b) includes forcing said seal into said annular groove, said body portion of said seal defining a radial plane and said directing curve lying in said radial plane such that said one or more components extend along each one of said one or more cross-sectional planes transversely to said radial plane.

26. The method as recited in claim 23 wherein said step b) includes forcing said seal into said annular groove, said body portion of said seal defining a radial plane and said directing curve being a circle lying in said radial plane such that said one or more components extend along each one of said one or more cross-sectional planes transversely to said radial plane.
